(19) United States
(12) Patent Application Publication
(10) Pub. No.: US 2026/0208464 A1
(43) Pub. Date: Jul. 23, 2026

(54) CLASS 1 UNINSULATED FLEXIBLE DUCT CONSTRUCTED OF POLYMER MATERIAL, HELICAL WIRE, FIRE RESISTANT BARRIER MATERIAL, AND FLAME RESISTANT YARN AND METHOD OF USE

(71) Applicant: ROYAL METAL PRODUCTS, Temple, GA (US)

(72) Inventor: Ronald L. CARLAY, II, Laurens, SC (US)

(73) Assignee: ROYAL METAL PRODUCTS, Temple, GA (US)

(21) Appl. No.: 19/570,616

(22) Filed: Mar. 18, 2026

Related U.S. Application Data
(63) Continuation-in-part of application No. 19/280,756, filed on Jul. 25, 2025.
Application No. 19/280,756 is a continuation-in-part of application No. 18/125,264, filed on Mar. 23, 2023.
(60) Provisional application No. 63/323,937, filed on Mar. 25, 2022.
(60) Provisional application No. 63/677,865, filed on Jul. 31, 2024.
(60) Provisional application No. 63/776,492, filed on Mar. 24, 2025.

(51) Int. Cl. B32B 1/08; B32B 3/04; B32B 3/08; B32B 5/02; B32B 7/12; B32B 27/08; B32B 27/12; B32B 27/36; B32B 37/12

(52) U.S. Cl. CPC B32B 1/08; B32B 3/04; B32B 3/08; B32B 5/022; B32B 7/12; B32B 27/08; B32B 27/12; B32B 27/36; B32B 37/1207; B32B 2037/1215; B32B 2255/02; B32B 2262/101; B32B 2307/3065; B32B 2597/00

(57) ABSTRACT

An uninsulated flexible duct includes a duct wall, the duct wall having an outer surface and an inner surface, the duct wall forming a channel for fluid flow therethrough and including a helical wire as a part thereof. The uninsulated flexible duct also includes a fire resistant barrier material forming a part of the duct wall. The fire resistant barrier material includes an overlap zone, wherein a first surface of the fire resistant barrier material faces a second surface of the fire resistant barrier material, the first and second surfaces of the overlap zone being bonded together. The duct also includes a flame resistant yarn adhered to an outer surface of the duct in a path that crosses or at least partially covers the overlap zone a plurality of times or is positioned between helical wires of the duct to assist in meeting a flame penetration test.

### FIELD OF THE INVENTION

The invention relates to UL 181 Class 1 uninsulated flexible duct with polymer core surrounded with a fire resistant barrier material and flame resistant yarn and a method of use.

### BACKGROUND ART

The use of smaller diameter uninsulated ducts for interior spaces like floors and walls in a structure is well known. An example of such a duct is the S-TL duct sold by Flexible Technologies, see https://thermaflex.net/products/thermaflex-s-tl-flexible-duct/. This prior art duct uses a fiberglass cloth fabric bonded to a wire helix to provide its Class 1 duct rating.

Reference to a Class 1 duct rating refers to the UL 181 standard published Jul. 25, 2013 and entitled UL Standard for Safety Factory-Made Air Ducts and Connectors. This standard describes a Class 1 rating as air ducts and air connectors having a flame-spread index of not over 25 without evidence of continued progressive combustion and a smoke-developed index of not over 50. Hereinafter, this standard is abbreviated as the UL 181 Class 1 duct standard.

Although the prior art S-TL duct provides the desired Class 1 rating that permits its use in interior spaces, its manufacturing process is complicated and expensive.

Furthermore, the demand for these kinds of duct applications have grown due to the use of different modes of cooling and heating for interior spaces of structures, wherein ductwork is more often utilized in a conditioned space such that the ductwork is not in need of additional insulation.

Even with improved duct designs, achieving the Class 1 UL 181 is not always guaranteed. Thus, there is still a need for improved duct designs and the invention responds to this need through an improved duct construction that uses a flame resistant yarn in combination with the uninsulated flexible ducts that use a fire resistant barrier material as a part thereof.

### SUMMARY OF THE INVENTION

The invention relates to flexible uninsulated ducts that meets the Underwriter Laboratories (UL) 181 Class 1 duct standard. One embodiment relates to a duct that has a specific duct construction and a second embodiment further modifies the duct to include a flame resistant yarn on the outside of the duct to facilitate meeting the UL 181 standard, including the flame penetration test.

In the first embodiment, the flexible uninsulated duct that meets Underwriter Laboratories (UL) 181 Class 1 duct standard has a polymer core that includes a helical wire as a part thereof, the polymer core forming an inner space for conditioned air flow, and having an outer surface. A fire resistant barrier layer is provided that surrounds the outer surface of the polymer core, the fire resistant barrier layer providing flame spreading and smoke development resistance such that the flexible uninsulated duct meets the UL 181 Class 1 duct standard. In the inventive duct construction, a first surface of the fire resistant barrier layer faces the outer surface of the polymer core and an outer surface of the fire resistant barrier layer is exposed to form an outer surface of the uninsulated duct.

While the polymer core can be any known polymer core typically used as part of a flexible duct construction, one example is a polymer core that uses a pair of PET layers with a helical wire positioned therebetween.

Since the inventive flexible insulated duct meets the UL 181 Class 1 duct standard, it can be installed in a structure at a length greater than 14 feet so as not to be considered a connector that falls under this standard as such a connector does not meet all of the tests required for a duct falling under the UL 181 Class 1 duct standard.

While the fire resistant barrier layer can be associated with the polymer core in any known fashion to keep the two together to form the composite duct construction, one mode of association is adhering the fire resistant barrier layer to the outer surface of the polymer core using an adhesive. As an alternative association between the fire resistant barrier layer and the polymer core, the fire resistant barrier layer can have first and second opposing longitudinal edges, with the edges sewn or stitched together such that the fire resistant barrier layer surrounds the outer surface of the polymer core.

While the fire resistant barrier layer can be any type of material that, when surrounding the polymer core, the composite duct structure would meet the UL 181 Class 1 duct standard, a preferred material would be a woven or non-woven fabric material containing fiberglass. An alternative material would be a fire resistant fleece comprising fire resistant staple fibers and optionally char scaffold fibers.

The invention also entails the use of one or more of the flexible uninsulated ducts for moving conditioned or unconditioned air therethrough in a given structure, wherein the one or more flexible uninsulated ducts is in an interior space of a structure, e.g., in floor or walls spaces of the structure, wherein further insulation for the inventive duct is not required.

Another aspect of the invention is the use of a combination of adhesives where the fire resistant barrier material is bonded together as part of the uninsulated duct construction, the combination of adhesives maintaining the integrity of the duct when subject to certain testing in conjunction with meeting requirements to qualify as a UL 181 Class 1 duct.

Another embodiment of the invention entails a flexible uninsulated duct that meets some or all of the Underwriter Laboratories (UL) 181 Class 1 duct standard and that uses a combination of adhesives to facilitate passing certain of the tests required under the UL 181 standard. This combination of adhesives enables the bond between the fire resistant barrier material to maintain its integrity and bonded overlap when subjected to high temperature and/or flame penetration testing and, at the same time, maintain the integrity of the duct construction during duct manufacture.

More particularly, the flexible uninsulated duct includes a polymer core having, optionally, a helical wire as a part thereof, the polymer core having first and second opposing surfaces. A fire resistant barrier layer with opposing first and second surfaces is provided, one of the first and second surfaces of the fire resistant barrier layer facing one of the first and second surfaces of the polymer core, the helical wire, if used, arranged therebetween. One of the first and second surfaces of the fire resistant barrier layer or one of the first and second surfaces of the polymer core forming an inside surface of the flexible uninsulated duct that forms a channel for conditioned air flow. When the polymer film forms the channel, the fire resistant barrier layer is exposed as an outside surface of the flexible uninsulated duct. When the fire resistant barrier layer forms the channel, the polymer film is all exposed as an outer surface of the flexible uninsulated duct.

In the duct construction, portions of the fire resistant barrier layer form an overlap, the overlap being either longitudinal seam running along a length of the duct or a spirally wound seam running along the length of the duct.

In one duct construction, a combination of at least first and second adhesives is provided between overlapping portions of the fire resistant barrier layer, the first adhesive is a hot melt adhesive in an effective amount to immediately bond the overlapping portions together, the second adhesive is a high temperature adhesive in an effective amount to maintain the bond between the overlapping portions when the longitudinal seam or spirally wound seam is subjected to at least a flame penetration test according to the UL 181 Class 1 duct standard.

In an alternative duct construction for the portions of the fire resistant barrier layer forming the overlap in either the longitudinal seam or a spirally wound seam of the duct, where again a combination of at least first and second adhesives between overlapping portions of the fire resistant barrier layer is used, the first adhesive is a hot melt adhesive in an effective amount to immediately bond the overlapping portions together, the second adhesive is a cold glue in an effective amount to maintain the bond between the overlapping portions when the longitudinal seam or spirally wound seam is subjected to a high temperature test according to the UL 181 Class 1 duct standard.

Preferably, the duct is the type that uses the longitudinal seam to bind the fire resistant barrier material together as part of the duct construction of the flexible uninsulated duct.

Preferably, the first adhesive is the hot melt adhesive and the second adhesive is a sodium silicate adhesive where the overlap of the duct will be exposed to flame during flame penetration testing.

Preferably, the first adhesive is the hot melt adhesive and the second adhesive is a cold glue where the overlap of the duct will be subjected to high temperature testing but not flame penetration testing.

When the hot melt adhesive is combined with the high temperature adhesive, e.g., sodium silicate, the hot melt adhesive is in contact with a portion of the sodium silicate adhesive located on at least one portion of the fire resistant barrier layer forming the overlap or the hot melt adhesive is adjacent to the sodium silicate adhesive in the overlap.

In another embodiment, the hot melt adhesive can be in contact with a portion of the sodium silicate adhesive as a continuous or discontinuous strip form or a discontinuous form made up of discrete portions of hot melt adhesive dispersed along the overlap.

When the hot melt adhesive is used with the cold glue, the hot melt adhesive and the cold glue can be kept generally separate from each other in the overlap, for example as adjacent strips of adhesive next to each other.

When the hot melt adhesive is combined with the high temperature adhesive, the hot melt adhesive covers 20-40% of an area of the overlap that is covered with the sodium silicate adhesive applied to the fire resistant barrier layer, preferably 25-35%.

The invention also includes a method of using the flexible uninsulated duct for supplying conditioned or unconditioned air to a space in any kind of structure or building needing such supply of air. The uninsulated nature of the flexible duct makes it ideal for use in inside walls of the structure as no insulated is need for such applications.

Another embodiment of the adhesive combination is the combination of a cold glue to provide the adhesion to maintain the integrity of the duct for processing and the high temperature adhesive to provide the ability to pass the flame penetration test. With this embodiment, the cold glue would require a drying/curing step as part of the cold glue application as, unlike the hot melt glue and its ability to create a bond almost instantaneously, the cold glue needs to set before bonding is complete. The combination of these adhesives would maintain bonding for high-temperature and flame penetration testing.

Another aspect of the invention is the use of a flame resistant yarn in combination with the ducts described above, the flame resistant yarn enhancing the ability of the duct to pass a flame penetration test.

In this embodiment, the uninsulated flexible duct includes a duct wall, the duct wall having an outer surface and an inner surface, the duct wall forming a channel for fluid flow therethrough, the duct wall including a helical wire. The duct also includes a fire resistant barrier material forming a part of the duct wall, the fire resistant barrier material including an overlap zone, wherein a first surface of the fire resistant barrier material faces a second surface of the fire resistant barrier material, the first and second surface of the overlap zone bonded together, the overlap zone running along a length of the uninsulated flexible duct.

Another feature of the duct is the use of a flame resistant yarn adhered to an outer surface of the duct in a path that crosses or at least partially covers the overlap zone or in a path wherein the yarn is centrally positioned between adjacent helical wires so that the yarn is generally aligned with a weight placed between helical wires in a flame penetration test.

In one embodiment, the fire resistant barrier layer can form the inside and/or the outside of the duct.

The overlap zone can run generally longitudinally along a length of the duct and the path of the flame resistant yarn crosses the overlap zone a plurality or times along a length of the duct or the overlap zone can run in a spiral path along the length of the duct.

The path of the flame resistant yarn can be one of:
a) a spiral path having a helix angle that is different than a helix angle of the spiral path of the overlap zone so that the flame resistant yarn crosses over or intersects the overlap zone; and
b) a spiral path having a helix angle the same as the spiral path of the overlap zone and wherein the spiral path of the flame resistant yarn is parallel to the spiral path of the overlap zone so that the flame resistant yarn runs along the overlap zone.

The overlap zone can also be bonded by chemical welding or the overlap zone can be bonded with a combination of adhesives, the combination comprising either:
(i) a combination of at least first and second adhesives between in the overlap zone, the first adhesive as a hot melt adhesive in an effective amount to immediately bond the overlapping portions together, the second adhesive as a high temperature adhesive in an effective amount to maintain the bond between the overlapping portions when the longitudinal seam or spirally wound seam is subjected to a flame penetration test according to the UL 181 Class 1 duct standard; or
(ii) a combination of at least first and second adhesives in the overlap zone, the first adhesive as a hot melt adhesive in an effective amount to immediately bond the overlapping portions together, the second adhesive as a cold glue in an effective amount to maintain the bond between the overlapping portions when the longitudinal seam or spirally wound seam is subjected to a high temperature test according to the UL 181 Class 1 duct standard.

In one embodiment, the fire resistant barrier material can include a coating thereon.

The duct wall can include at least one polymer layer as a part thereof, the at least one polymer layer and the fire resistant barrier material forming a laminate construction for the duct wall, and optionally, the fire resistant barrier material can form an outer or inner surface of the uninsulated flexible duct.

The flame resistant yarn is adhered to an outer surface of the fire resistant barrier material by one of:
a) a high temperature adhesive;
b) a polyvinylchloride coating on the yarn and tetrahydrofuran applied to the coated yarn to chemically weld it to the outer surface of the duct;
c) a coating applied to the yarn and fire resistant barrier material, and
d) a stitching of the flame resistant yarn to the outer surface of the duct.

Another duct construction includes a coated fire resistant barrier material that forms both an inner and outer surface of the duct, the overlap zone runs generally longitudinally along a length of the duct, and the path of the flame resistant yarn is a spiral path that crosses over or intersects the overlap zone.

The invention also includes a method of flame penetration testing of the flame resistant yarn-containing duct, wherein an outer surface of a section of uninsulated flexible duct is configured to face a furnace with an open flame, the improvement comprising providing the section of duct from any one of the ducts described above.

The invention also is an improvement in a method of moving conditioned or unconditioned fluid, preferably air, using an uninsulated flexible duct, wherein the improvement is providing any one of the flame resistant yarn-containing duct constructions described above to move the conditioned or unconditioned fluid.

### BRIEF DESCRIPTION OF THE DRAWINGS

FIG. 1 shows a cross sectional view of an embodiment of the inventive duct.

FIG. 2 shows an exemplary use of the inventive duct in a wall space.

FIG. 3 shows another embodiment of the inventive duct.

FIG. 4 shows a section of the fire resistant barrier layer of the inventive duct in connection with duct manufacture.

FIG. 5 shows a cross section of the duct of claim 1, wherein the overlap portion of the fire resistant barrier material at the longitudinal seam of the duct uses an adhesive to bond the ends of the fire resistant barrier material together to form the uninsulated duct.

FIG. 6 shows an enlarged part of the overlap “O” of FIG. 5, showing schematically the adhesive combination used in the overlap portion.

FIG. 7 shows the overlap of FIG. 6 with one embodiment of the adhesive combination used to form the longitudinal seam of the duct.

FIG. 8 shows the overlap of FIG. 6 with another embodiment of the adhesive combination used to form the longitudinal seam of the duct.

FIG. 9 shows yet another embodiment of the adhesive combination showing a longitudinal length of the seam.

FIG. 10 shows the overlap of FIG. 6 in a further embodiment of the adhesive combination used to form the longitudinal seam of the duct.

FIG. 11 shows the overlap of the fire resistant barrier material in a spirally wound duct and the adhesive combination in a schematic representation.

FIG. 12A shows a schematic drawing of a side view of flexible duct that includes a longitudinal seam and a flame resistant yarn surrounding the outside surface thereof.

FIG. 12B shows a top view of the duct of FIG. 12A.

FIG. 13A shows a schematic drawing of a flexible duct that includes a spiral seam extending along a length thereof and the flame resistant yarn in a particular helix angle covering the duct.

FIG. 13B shows a schematic drawing of a flexible duct that includes a spiral seam extending along a length thereof and yarn in a particular helix angle covering the duct different from the helix angle shown in FIG. 13A.

FIG. 13C shows another schematic drawing of a flexible duct that includes a spiral seam and a different configuration of the flame resistant yarn.

FIG. 14A shows a schematic view of a section of a longitudinal seam-containing duct in a frame that is intended to be used in a flame penetration test.

FIG. 14B shows a schematic view of a section of a spiral wound duct in a frame that is intended to be used in a flame penetration test.

FIG. 15 shows a side view of the section of duct of FIG. 14A as it would be oriented for a flame penetration test.

FIG. 16 shows another embodiment of the invention, wherein the yarn is positioned so that the flame penetration test weight is placed over the yarn.

FIG. 17 is an alternative embodiment to that of FIG. 16, wherein the yarn is under the weight but also associated with the overlap zone of the duct.

FIG. 18 shows a duct section of S-TL duct and how the yarn would be positioned with respect to wire and overlap zones thereof.

### DETAILED DESCRIPTION OF THE INVENTION

In one embodiment, the flexible uninsulated duct that meets Underwriter Laboratories (UL) 181 Class 1 duct standard has a polymer core that includes a helical wire as a part thereof, the polymer core forming an inner space for conditioned air flow, and having an outer surface. A fire resistant barrier layer is provided that surrounds the outer surface of the polymer core, the fire resistant barrier layer providing flame spreading and smoke development resistance such that the flexible uninsulated duct meets the UL 181 Class 1 duct standard. In the inventive duct construction, a first surface of the fire resistant barrier layer faces the outer surface of the polymer core and an outer surface of the fire resistant barrier layer is exposed to form an outer surface of the uninsulated duct.

While the polymer core can be any known polymer core typically used as part of a flexible duct construction, one example is a polymer core that uses a pair of PET layers with a helical wire positioned therebetween.

Since the inventive flexible insulated duct meets the UL 181 Class 1 duct standard, it can be installed in a structure at a length greater than 14 feet so as not to be considered a connector that falls under this standard as such a connector does not meet all of the tests required for a duct falling under the UL 181 Class 1 duct standard.

While the fire resistant barrier layer can be associated with the polymer core in any known fashion to keep the two together to form the composite duct construction, one mode of association is adhering the fire resistant barrier layer to the outer surface of the polymer core using an adhesive. As an alternative association between the fire resistant barrier layer and the polymer core, the fire resistant barrier layer can have first and second opposing longitudinal edges, with the edges sewn or stitched together such that the fire resistant barrier layer surrounds the outer surface of the polymer core.

While the fire resistant barrier layer can be any type of material that, when surrounding the polymer core, the composite duct structure would meet the UL 181 Class 1 duct standard, a preferred material would be a woven or non-woven fabric material containing fiberglass. An alternative material would be a fire resistant fleece comprising fire resistant staple fibers and optionally char scaffold fibers.

The invention also entails the use of one or more of the flexible uninsulated ducts for moving conditioned or unconditioned air therethrough in a given structure, wherein the one or more flexible uninsulated ducts is in an interior space of a structure, e.g., in floor or walls spaces of the structure, wherein further insulation for the inventive duct is not required.

Another aspect of the invention is the use of a combination of adhesives where the fire resistant barrier material is bonded together as part of the uninsulated duct construction, the combination of adhesives maintaining the integrity of the duct when subject to certain testing in conjunction with meeting requirements to qualify as a UL 181 Class 1 duct.

Another embodiment of the invention entails a flexible uninsulated duct that meets some or all of the Underwriter Laboratories (UL) 181 Class 1 duct standard and that uses a combination of adhesives to facilitate passing certain of the tests required under the UL 181 standard. This combination of adhesives enables the bond between the fire resistant barrier material to maintain its integrity and bonded overlap when subjected to high temperature and/or flame penetration testing and, at the same time, maintain the integrity of the duct construction during duct manufacture.

More particularly, the flexible uninsulated duct includes a polymer core having, optionally, a helical wire as a part thereof, the polymer core having first and second opposing surfaces. A fire resistant barrier layer with opposing first and second surfaces is provided, one of the first and second surfaces of the fire resistant barrier layer facing one of the first and second surfaces of the polymer core, the helical wire, if used, arranged therebetween. One of the first and second surfaces of the fire resistant barrier layer or one of the first and second surfaces of the polymer core forming an inside surface of the flexible uninsulated duct that forms a channel for conditioned air flow. When the polymer film forms the channel, the fire resistant barrier layer is exposed as an outside surface of the flexible uninsulated duct. When the fire resistant barrier layer forms the channel, the polymer film is all exposed as an outer surface of the flexible uninsulated duct.

In the duct construction, portions of the fire resistant barrier layer form an overlap, the overlap being either longitudinal seam running along a length of the duct or a spirally wound seam running along the length of the duct.

In one duct construction, a combination of at least first and second adhesives is provided between overlapping portions of the fire resistant barrier layer, the first adhesive is a hot melt adhesive in an effective amount to immediately bond the overlapping portions together, the second adhesive is a high temperature adhesive in an effective amount to maintain the bond between the overlapping portions when the longitudinal seam or spirally wound seam is subjected to at least a flame penetration test according to the UL 181 Class 1 duct standard.

In an alternative duct construction for the portions of the fire resistant barrier layer forming the overlap in either the longitudinal seam or a spirally wound seam of the duct, where again a combination of at least first and second adhesives between overlapping portions of the fire resistant barrier layer is used, the first adhesive is a hot melt adhesive in an effective amount to immediately bond the overlapping portions together, the second adhesive is a cold glue in an effective amount to maintain the bond between the overlapping portions when the longitudinal seam or spirally wound seam is subjected to a high temperature test according to the UL 181 Class 1 duct standard.

Preferably, the duct is the type that uses the longitudinal seam to bind the fire resistant barrier material together as part of the duct construction of the flexible uninsulated duct.

Preferably, the first adhesive is the hot melt adhesive and the second adhesive is a sodium silicate adhesive where the overlap of the duct will be exposed to flame during flame penetration testing.

Preferably, the first adhesive is the hot melt adhesive and the second adhesive is a cold glue where the overlap of the duct will be subjected to high temperature testing but not flame penetration testing.

When the hot melt adhesive is combined with the high temperature adhesive, e.g., sodium silicate, the hot melt adhesive is in contact with a portion of the sodium silicate adhesive located on at least one portion of the fire resistant barrier layer forming the overlap or the hot melt adhesive is adjacent to the sodium silicate adhesive in the overlap.

In another embodiment, the hot melt adhesive can be in contact with a portion of the sodium silicate adhesive as a continuous or discontinuous strip form or a discontinuous form made up of discrete portions of hot melt adhesive dispersed along the overlap.

When the hot melt adhesive is used with the cold glue, the hot melt adhesive and the cold glue can be kept generally separate from each other in the overlap, for example as adjacent strips of adhesive next to each other.

When the hot melt adhesive is combined with the high temperature adhesive, the hot melt adhesive covers 20-40% of an area of the overlap that is covered with the sodium silicate adhesive applied to the fire resistant barrier layer, preferably 25-35%.

The invention also includes a method of using the flexible uninsulated duct for supplying conditioned or unconditioned air to a space in any kind of structure or building needing such supply of air. The uninsulated nature of the flexible duct makes it ideal for use in inside walls of the structure as no insulated is need for such applications.

Another embodiment of the adhesive combination is the combination of a cold glue to provide the adhesion to maintain the integrity of the duct for processing and the high temperature adhesive to provide the ability to pass the flame penetration test. With this embodiment, the cold glue would require a drying/curing step as part of the cold glue application as, unlike the hot melt glue and its ability to create a bond almost instantaneously, the cold glue needs to set before bonding is complete. The combination of these adhesives would maintain bonding for high-temperature and flame penetration testing.

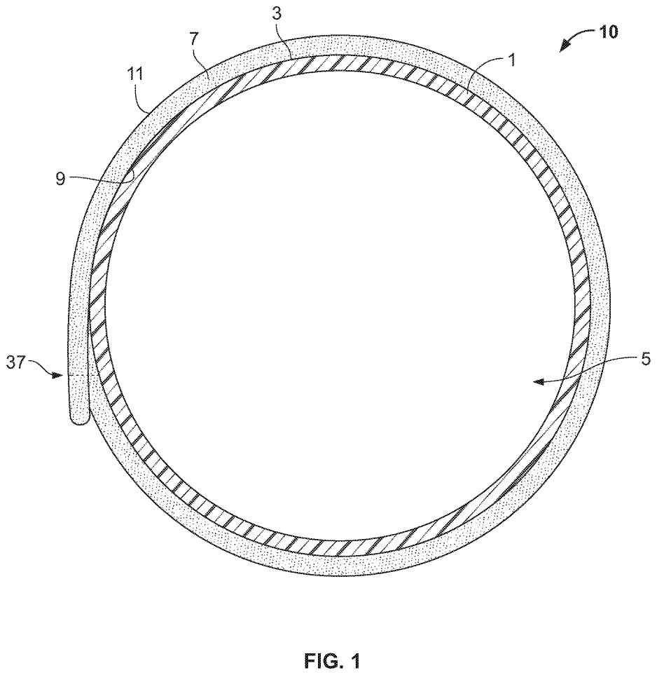

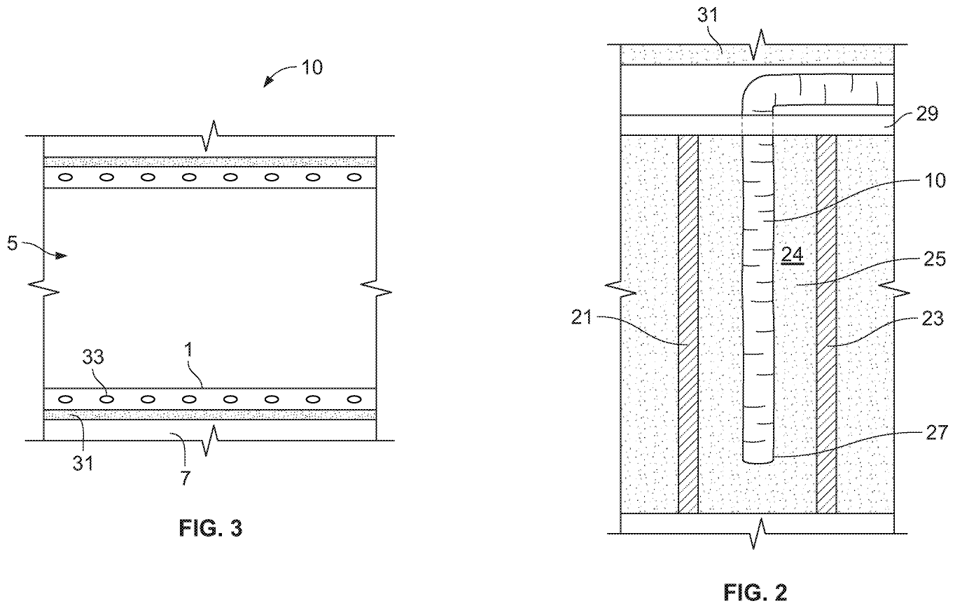

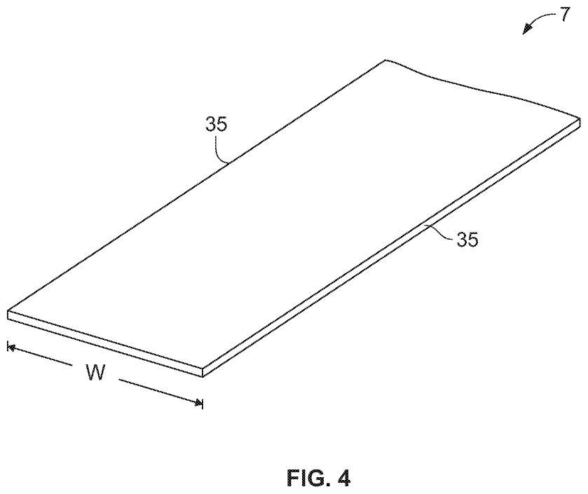

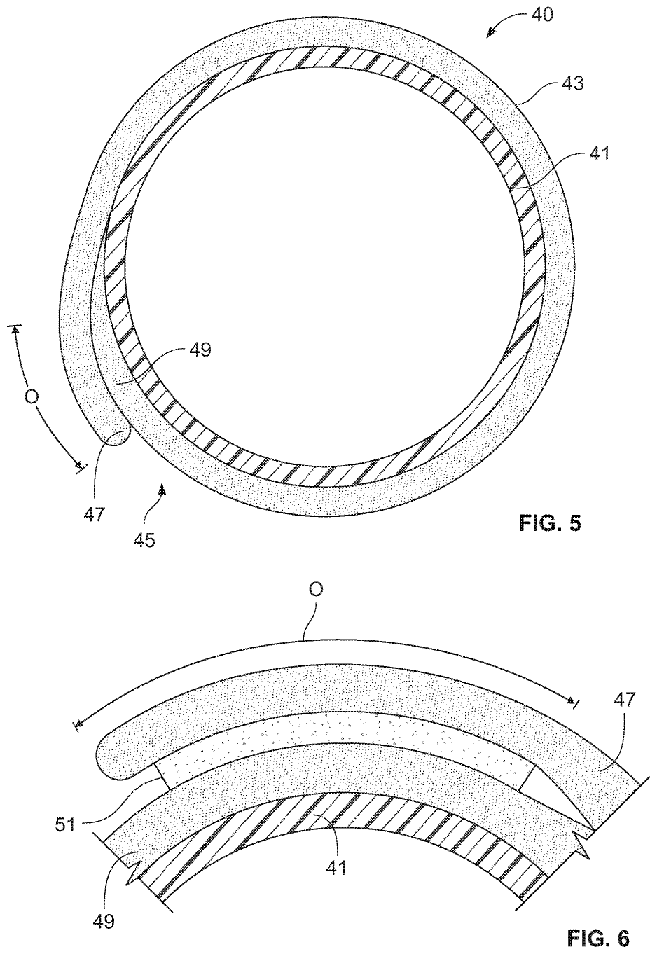

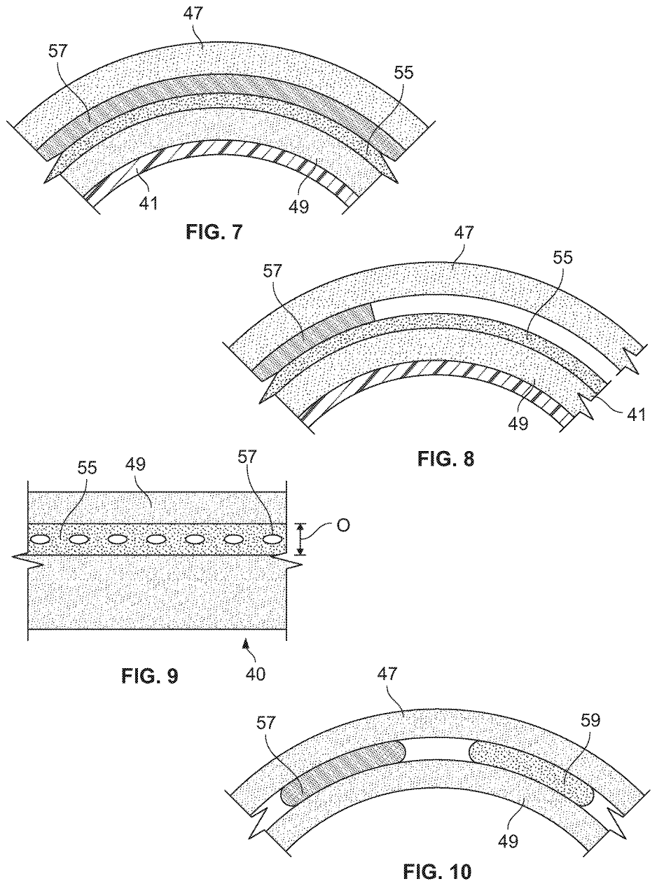

FIGS. 1-11 shows different kinds of flexible duct constructions. One type uses a fire resistant barrier material that forms part of the duct construction that includes a polymer film and is held together with a longitudinal seam that has an overlap zone that is glued together. Another type of duct is one of similar duct wall construction as the duct with the longitudinal seam but instead includes spiral wound construction, wherein the seam and its related overlap zone spirals along the length of the duct. The overlap zone of the seam in the spiral wound duct is also held together by adhesive action. In either duct, there is essentially one overlap zone, that runs either generally longitudinally along the length of the duct or runs in a spiral or helical pattern along the length of the duct.

A third kind of duct that is similar to the ducts described above is one that uses a coated fiberglass cloth fabric that is permanently bonded to a corrosion resistant steel wire helix and does not employ any polymer film. This kind of duct is considered a non-insulated flexible duct like those of FIGS. 1-11 and an example of such a duct is sold by Thermaflex as its S-TL Flexible Duct. This third kind of duct also employs a spiral seam to connect ends of the fiberglass cloth together. In this embodiment, the seam and its overlap zone are preferably secured by a chemical welding process rather than just the use of adhesives. Since this duct is well known, an illustration of it is not necessary for understanding of the invention. The overlap is where one surface of the fire resistant barrier material, i.e., the coated fiberglass cloth fabric, faces another surface of the fire resistant barrier layer to create an overlap zone that runs the length of the duct.

As noted above, one problem with ducts using an adhesive to secure an overlap zone of the duct material together during duct manufacture is the ability for such a construction to pass the UL 181 flame penetration test. In this test, a section of the duct material is placed over a flame, with the outer surface of the duct facing the flame and an inner surface of the duct carrying a weight. The duct is held in place for a certain period of time to ensure that the duct structure remains intact during the flame penetration test. The embodiments described above with different combinations of adhesives are intended to maintain the duct structure while the duct is subjected to a flame penetration test as well as other tests that are required by UL 181 so that the duct can be properly certified.

While it is believed that the combination of adhesives used in the longitudinal seam-containing flexible ducts and spiral wound ducts are sufficient to hold the duct together to pass the flame penetration test, there is the possibility due to manufacturing variances or other conditions or circumstances that these kinds of ducts may not always pass the flame penetration test for UL 181 certification. It is also possible that the duct only using the steel helical wire and fire resistant barrier material can fail the flame penetration test in spite of the much more robust bonding that occurs at the overlap zone of this kind of duct.

As such, a need exists to ensure that at least the three kinds of ducts described above can all pass the flame penetration tests even when a novel combination of adhesives or a more robust bonding technique like chemical welding is used. This need is satisfied with yet another embodiment of the invention wherein a flame resistant yarn is employed around the outside surface of the uninsulated flexible ducts described above.

Flexible ducts that would be candidates to use the flame resistant yarn include a duct having a longitudinal seam and the combination of a fire resistant barrier material and a polymer core, wherein the duct includes a helical wire as a part thereof. The fire resistant barrier material could form the outside surface of the duct and surround the polymer core, wherein the polymer core would include the inside surface of the duct and form the channel for fluid flow. Alternatively, the polymer core could surround the fire resistant barrier material so that the fire resistant barrier material would include the inner surface of the duct and form the channel, with the polymer core including the outer surface of the duct.

Instead of the spiral wound S-TL duct, this kind of duct could be conceivably made with a longitudinal seam wherein the duct combines the fire resistant barrier material and helical wire, i.e., no polymer core.

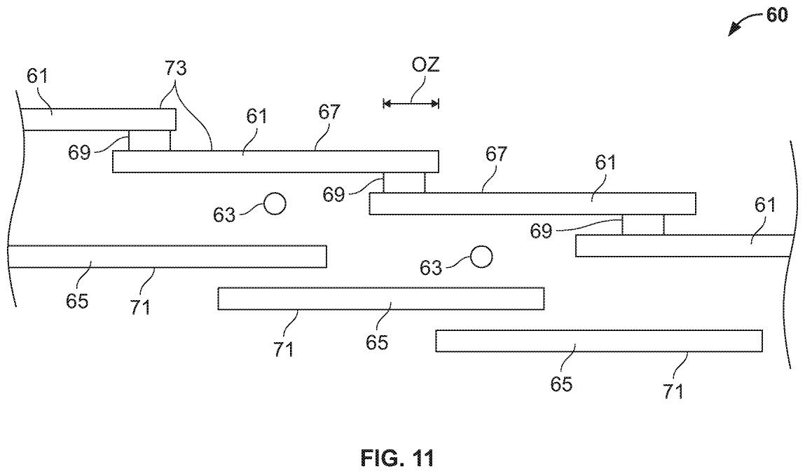

Spiral wound ducts are also candidates to use the flame resistant yarn as a component part thereof. The construction of these kinds of ducts can vary as compared to the more simplified construction of the longitudinal seam containing ducts noted above. The construction of these ducts still uses the fire resistant barrier material, but this barrier material may be positioned between two polymer films, and this laminate construction as a tape of defined width is then spirally wound on a mandrel to make the duct. An alternative duct construction would be where the fire resistant barrier material is combined with a single polymer film to make a laminate construction as a tape of defined width that is then spirally wound on a mandrel to create the duct, this construction shown above in FIG. 11 and its description. No matter what the makeup of the laminate construction, a component part of these spiral wound ducts is a seam and overlap zone between one edge surface of the tape that overlaps another edge surface of the tape during the spiral winding of the tape on a mandrel. Regardless of the construction of the spiral wound duct, the overlap zone includes some kind of bonding, e.g., the adhesive combination described above to ensure that the overlap zone of the fire resistant barrier material remains intact during testing.

Of course, any other kind of duct construction that is the uninsulated flexible type, includes a seam and overlap zone, and would be subjected to flame penetration testing is a candidate duct to include the flame resistant yarn as a component part thereof help maintain the integrity of the seam and overlap zone during flame penetration testing.

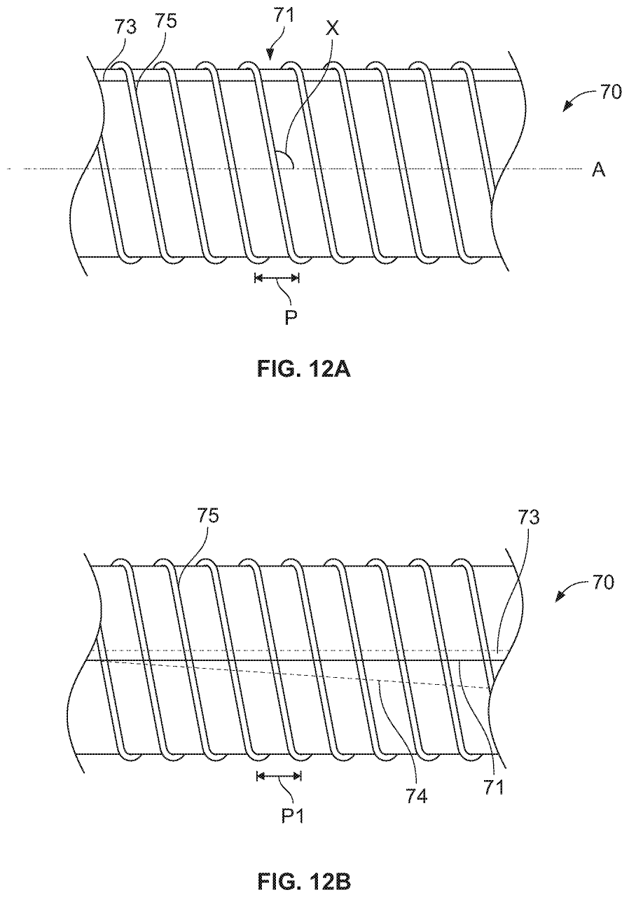

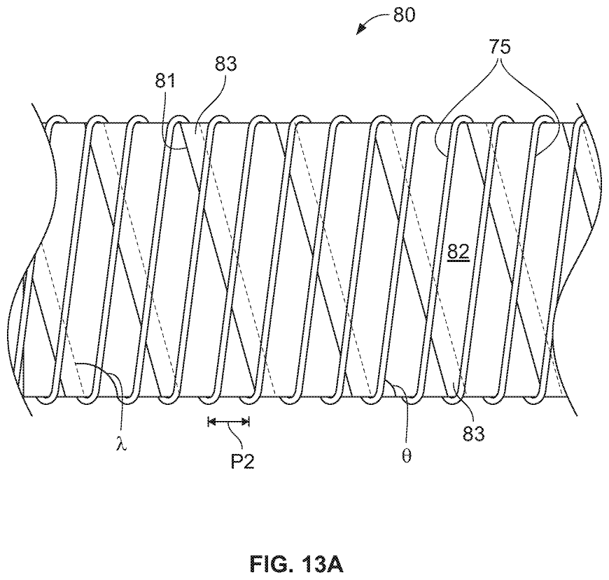

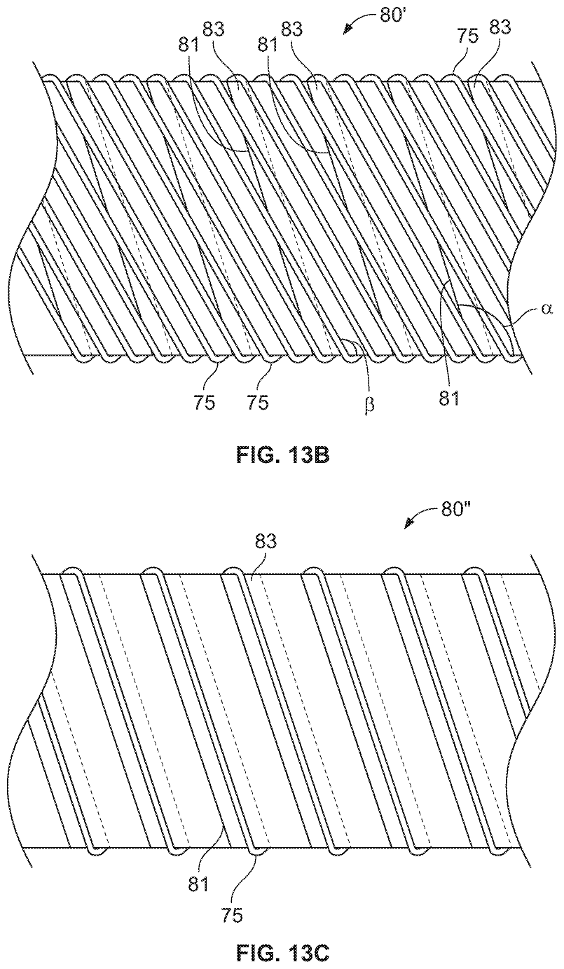

Two different duct constructions are exemplified to show how the flame resistant yarn is used with the ducts to improve capability of passing flame penetration testing. One duct construction relates to a duct with a longitudinal seam and overlap zone and this is shown in FIGS. 12A and 12B. The other relates to a spiral wound duct construction, that is shown in FIGS. 13A-C.

FIGS. 12A and 12B shows a schematic view of a longitudinal seam-containing duct designated by the reference numeral 70, with FIG. 12A showing a side view and FIG. 12B showing a top view. The longitudinal seam is designated by the reference numeral 71 and the overlap zone is designated by the reference numeral 73. The duct 70 can be like the adhesive combination containing-duct with a longitudinal seam as described above of the duct or the duct that only uses the fiberglass cloth material with the steel helical wire. While the seam 71 runs straight between ends of the duct (not shown) the seam 71 could run askew, as shown by the path 74, see FIG. 12B.

The flame resistant yarn 75 wraps spirally around the duct 70 as shown in FIGS. 12A and 12B. While any flame resistant yarn or filamentous material can be used, examples of those commercially available include Kaneka Modacrylic Protex-C, which will not melt or drip when ignited, Performance Products Celazone PBI, which does not readily ignite or exhibit a melting point, Dupont Nomex, which melts and decomposes at approximately 350° C., Dupont Kevlar, whose melting point is about 500° C., and Kuraray Vectran, whose melting point is 330° C.

The purpose of the yarn is to provide an additional means to keep the longitudinal seam intact should the adhesive or other bonding medium, e.g., chemical welding, fail when a section of the duct is subjected to a flame penetration test. With the yarn on the outside of the surface of the duct, the section of duct used in the flame penetration test would have the yarn facing the flame of the test. With the yarn resistant to failure due its flame resistant properties, the yarn would remain in place even if the bond at the longitudinal seam overlap zone would fail/come apart and the duct would remain intact and avoid a failure of the flame penetration test. One reason that yarn is applied on the outside of the duct is that weight pushes on top of the duct section that is being tested (inside surface of duct) and yarn supports the flame resistant material from underneath preventing the weight from separating the overlap and allowing flames to penetrate the sample (failure). Ideally, the yarn placement would be positioned under the weight; however, even when not under the weight the yarn indirectly supports the weight by supporting the flame resistant barrier material.

The yarn 75 can be adhered to the outside surface of the duct in any known manner so that it stays in place at least for the mechanical tests, the high temperature test (260 degrees F.), and the low temperature test (0 degrees F. for 24 hours) that are part of the UL 181 Class 1 duct testing regimen. It is not critical that the adherence of the yarn be such that the yarn would necessarily remain adhered to the outer surface of the duct during flame penetration testing. The reason for this is that the duct section used in the flame penetration test has one of its two opposing sides clamped in a frame that supports the duct section during testing. This clamping of the two opposing sides also effectively holds the yarn in place to provide the needed support for the seam/overlap zone of the duct section and prevent loss of integrity of the duct section if the seam and its overlap zone should come apart.

Examples of means for adhering the yarn to the outside of the duct include:
a) a high temperature adhesive (withstand temperatures of at least 300 degrees F.), which includes some of the adhesives described above, both cold glues and high temperature adhesives;
b) the yarn could be coated in PVC and tetrahydrofuran could be used on the yarn to chemically weld it to the outer surface of the duct;
c) in embodiments wherein the outside surface of the duct is the fire resistant barrier material that is coated for duct making, the yarn could be placed on the outer surface of the duct prior to the coating, e.g., a dip coating, with the dip coating not only providing the coating on the fire resistant barrier material but also acting as a means for adhering the yarn to the fire resistant barrier material during the dip coating step (in other words, the dip coating would keep the yarn in place when the coated fire resistant barrier material is made into the duct); and
d) the yarn could be stitched to the outside of the duct so that it is held in place.

In fact, any known method of securing a filament type flame resistant material to the outside of cylindrical object like an uninsulated flexible duct can be employed so that the yarn is arranged in the desired configuration and fulfills its function as supporting the overlap zones in the duct that are bonded together so that the duct integrity is maintained for UL 181 testing, particularly flame penetration testing.

Referring again to FIGS. 12A and 12B, the pitch of the helix of yarn is shown as P1 and can vary between a small pitch value to a large pitch value. The pitch cannot be too large as it may not sufficiently hold the seam 71 together during a flame penetration test. A range for the pitch would be between 0.5 and 4.0 inches, with a more preferred range being 1 and 2 inches. In terms of the helix angle of the yarn 75 in FIG. 12A, when measured with respect to an axis A of the duct, the helix angle x is obtuse or greater than 90 degrees. While the yarn is shown with a helix angle greater than 90 degrees in FIGS. 12A and 12B, an opposite orientation can also be used, wherein the yarn would angle to the right and have a helix angle less than 90 degrees or an acute angle. While the width of the overlap zone can vary as is known in the art, typical widths are in the 0.25 to 3 inch range, with a preference of about two inches. Overlap zone widths for spiral wound ducts are generally less given that the length of the spiral path of the overlap zone for these kinds of ducts is much longer as compared to the longitudinal seam-containing duct. Thus, minimizing the width of the overlap zone while maintaining bond integrity at the overlap zone is desired to reduce the overall amount of material to make a given duct.

Referring to FIG. 13A, a schematic drawing of a spiral wound duct 80 is shown, which is representative of spiral wound ducts like that shown in FIG. 11, wherein a tape is successively wound around a mandrel with the inventive adhesive combination used in the spiral path following overlap zone to maintain the integrity of the duct during use and testing. The spiral winding of the duct material forms a seam 81 that extends in a helical pattern along the length of the duct 80. Each seam 81 also includes an overlap zone 83, wherein adjacent duct material, i.e., opposing surfaces in the overlap zone, are glued together as described above with the combination of adhesives.

The flame resistant yarn 75 is shown in FIG. 13A with a helix angle θ that results in the yarn 75 intersecting both the seam 81 and overlap zone 83. For consistency purposes, the helix angle is measured with respect to the axis of the duct as described above but show for clarity with respect to the outer part of the duct. Thus, the helix angle θ in FIG. 13A would be an acute angle and the helix angle θ of the seam 81 would be an obtuse angle, the helix angle θ having a direction generally opposite that of the helix angle λ of the seam 81. This intersecting configuration is achieved by having the helix angle θ for the yarn 75 to be less than 90 degrees and the helix angle λ for the seam 81 to be greater than 90 degrees. The respective angles can vary but should each be arranged to have the intersecting arrangement so that the yarn 75 crosses over or intersects with the seam 81 and overlap zone 83 during the flame penetration test. Typically, the helix angle λ for the spiral wound duct is ranges between about 100 and 135 degrees and with this angulation, a target range for the yarn would be between 45 and 85 degrees.

For a spiral wound duct, the arrangement of the yarn in FIG. 13A, wherein the yarn crosses over or intersects with the seam and overlap zone is a preferred embodiment. However, the yarn could have other orientations as it surrounds the outer surface 82 of the duct 80. It could spiral in a direction opposite to that shown in FIG. 13A as shown in FIG. 13B with duct 80′. In this embodiment, the seam 81 has a helix angle α and the yarn 75 has a helix angle β. The helix angle β of the yarn should be less than the helix angle α of the seam to ensure that the yarn 75 crosses over or intersects the seam 81 along the length of the duct.

The helix angles for the yarn 75 and seam 81 could also match such that the yarn would be parallel to the seam 81. In this embodiment though, the location of the yarn helix should be such that the yarn 75 covers the overlap zone to ensure section integrity if the overlap zone would come apart during flame penetration testing. This configuration is shown in FIG. 13C as duct 80″, wherein the yarn 75 runs parallel to the seam 81 and at the same time runs on the overlap zone 83.

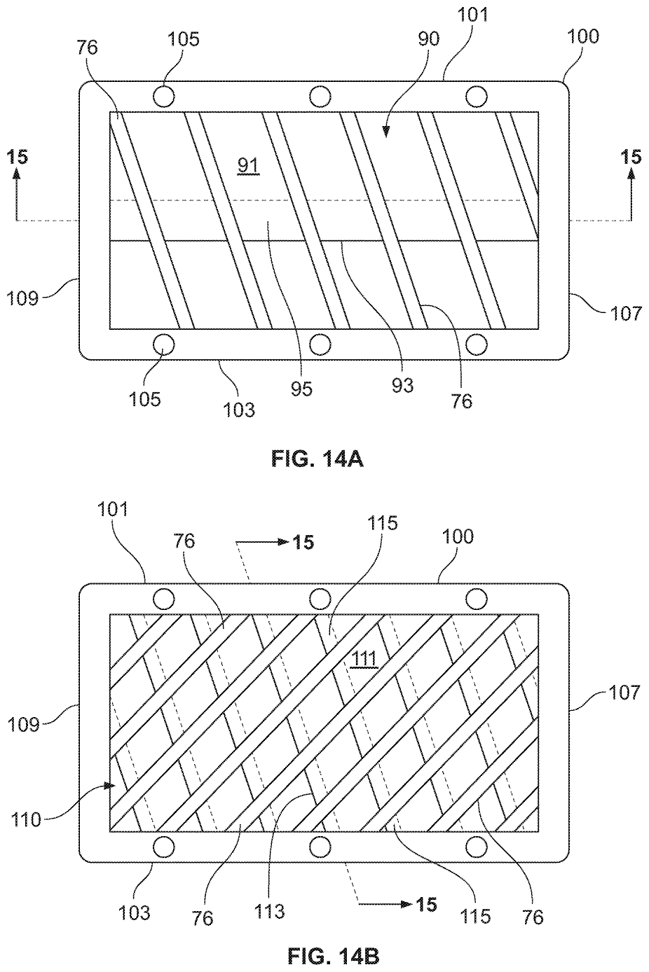

FIG. 14A shows a schematic drawing of a section of a duct in a frame, wherein the duct-containing frame would be used in the flame penetration testing. The duct section is designated by reference numeral 90 and the surface 91 would correspond to the outer surface of the duct and the one that faces the flame in the flame penetration test. Preferably, the section 90 would also include the longitudinal seam 95 and the bonded overlap zone 93. The section 90 is also shown in a frame 100, that is the kind used in the flame penetration test. The frame 100 is generally rectangular in shape and is bolted to a base plate on only two opposing sides 101 and 103, the bolts depicted as 105. The bolted sides 101 and 103 support the section 90, with the other two sides 107 and 109 providing minimal means of support for the section 90, i.e., the weight of the frame laying on the duct section.

FIG. 14A also illustrates how the yarn segments 76 of the duct section 90 would also be clamped in the frame. When using a duct like the S-TL duct, which is an uninsulated duct that has a woven fiberglass cloth that has a helical wire integrated with it to form the duct wall, the helical wire is essentially clamped in the frame as its thickness or diameter is greater than the thickness of the fiberglass cloth.

When using a duct section including a helical wire and the fire resistant barrier material, such as the S-TL duct, the yarn diameter should be greater than the diameter of the wire. The reason for this is as follows. As noted above, it is the ends of the helical wire in the duct section that are essentially clamped in the frame for the flame penetration test. If the wire diameter of the helical wire is greater than the yarn diameter, the yarn would not necessarily be clamped. Thus, during flame penetration testing, the adherence of the yarn to the outer surface of the duct could fail and, if the yarn is not of the sufficient size diameter, it could conceivably pullout or be forced out of the clamped section 100 by the weight pressing of the clamped section of the duct section 90. With the yarn pulling out, the support for the seam and its overlap zone is removed and the seam could come apart during the flame penetration test, and the duct would be given a failing grade. With the yarn diameter greater than the wire diameter, the difference being such that the yarn ends of the duct section are held in place rather than just the ends of the helical wire, the duct section is then held in place. In other words, the yarn is securely engaged by the clamping sides 101 and 103 and the duct section is held in the frame as a result of this engagement for testing purposes. Typically, the diameter of the helical wire is in the range of 0.04 to 0.075 inches so that the yarn diameter should be greater than the helical wire diameter falling in this range.

FIG. 14B shows a schematic drawing of a duct section 110 of a spiral wound duct that would also be subjected to flame penetration testing. Here, the duct section 110 includes a surface 111 that would correspond to the outer surface of the duct. Also shown are the seams 113 and overlap zones 115 that would spirally run along the length of the duct. As in FIG. 14A, ends of the yarn segments 76 would be clamped by the opposing sides 101 and 103 of the frame 100 using the bolts 105, such clamping keeping the yarn in place during the flame penetration testing and ensuring maintenance of the integrity of the duct should the overlap zone 115 come apart.

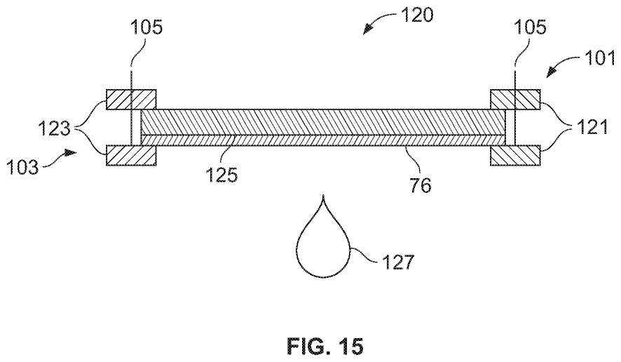

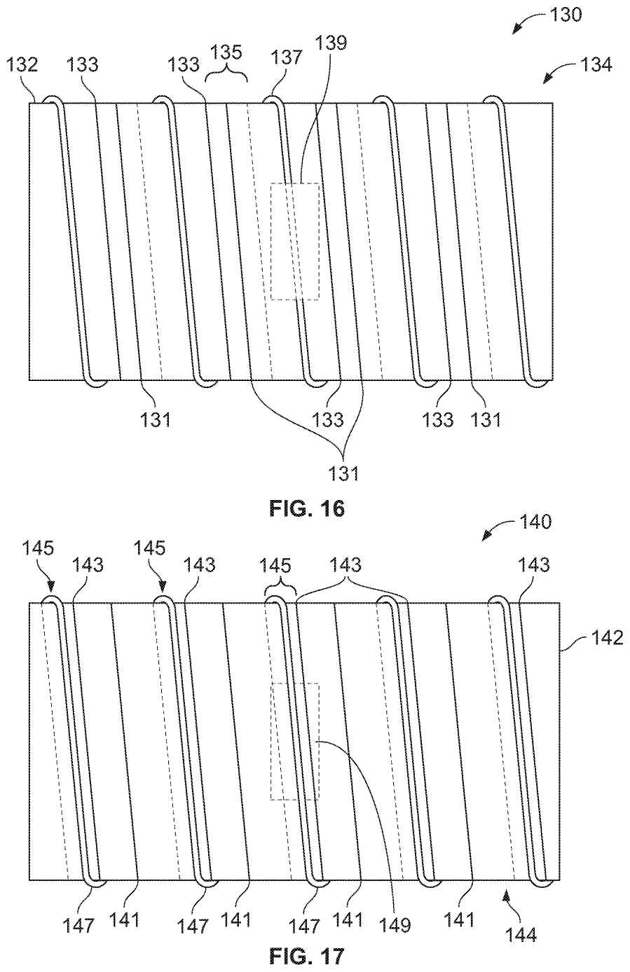

FIG. 15 is a schematic side view illustration of the duct section 120 along the line XV-XV of FIG. 14B. This line corresponds to a run of the yarn segment 76. The construction of the duct section can be any kind described below as FIG. 15 is intended to show the clamping of the yarn segment 76 for the flame penetration test. The opposing sides 101 and 103 of the frame 100 are essentially a pair of plates 121 and 123 that are compressed using the bolts 105 for clamping purposes. The ends of the yarn segments 76 are clamped between the respective plates 121 and 123 to hold the yarn in place. As noted above, with this yarn clamping, the manner of adhesion of the yarn to the outer surface of the duct does not necessarily have to adhere to the duct section as its main purpose is to support the duct section should the bond at the any of the overlap zones in the duct section test piece fail during the flame penetration test. This view illustrates how the outer surface 125 of the duct would face a flame 127 during the flame penetration test. Again, the yarn segments 76 would support the fire resistant barrier material of the duct section and the overlap zone and maintain the integrity of the duct even if the medium used in the overlap zone to keep the seam intact would fail during the flame penetration testing.

While it is preferred that the duct construction, whether having a longitudinal seam or a spiral seam, includes the adhesive combinations disclosed above for the overlap zone for the fire resistant barrier material, a duct using a single adhesive that would have the necessary qualities such that the duct would not only meet the flame penetration test but the other tests associated with obtaining a Class 1 duct UL 181 rating is within the scope of the invention. It is believed that, even with the use of a cold glue for the overlap of the fire resistant barrier material, if the yarn is positioned between the wires of the duct section, the yarn would be positioned beneath the weight, which is typically 1″×4″ in a horizontal cross section, during a flame penetration test and the yarn would resist the weight and prevent the overlap of the fire retardant barrier material from coming part.

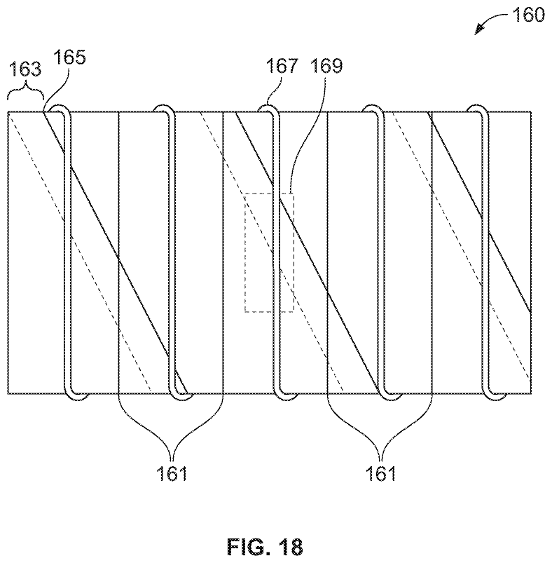

Referring back to FIGS. 14B and 15, the helical wire that is part of the core of the duct is not shown but it would run parallel to the overlap zones 115 in this Figure and the yarn 76 would cross over the helical wire and overlap zones, similar to that shown in FIG. 18, wherein the helical wire (not shown) would run parallel to the overlap zone 163. In the embodiment of FIG. 14B, when a section of the duct is clamped in the frame 101, the helical wire would cross the yarn 76. More specifically and referring to FIG. 15 in this regard, the yarn 76 and helical wire (not shown) would be in a crossed configuration between the opposing frame sections 121 and 123. Clamping of the frame sections 121 and 123 could possibly sever the yarn by the helical wire cutting through the yarn during clamping. If the yarn is severed, it would no longer be held in the frame 101 during the flame penetration testing and provide its support during said testing. Thus, for a duct construction that would have the yarn and helical wire cross in the frame 101 as would be the case for the section in FIG. 14B, the yarn should not only be a fire resistant type but also a cut resistant type. These kinds of yarns are well known and examples of such yarns would be meta aramid fiber, para aramid fibers, fibers reinforced with tungsten, stainless steel filaments, fibers coated with protective coatings that provide cut resistance, and combinations of cut resistant and flame resistant materials. The fact that the wire of the core pinches the yarn between the frame components used in the flame penetration test is an advantage. With the wire pinching the yarn, the yarn selected to be a type that is resistant to being cut when pinched and flame resistance, the yarn is locked into the frame and held firmly in place. This approach in terms of the yarn type and pinching of the yarn by the wire and frame permits the use of an existing duct component, i.e., the wire, to allow a yarn of a diameter smaller than the wire diameter to be used effectively to support the weight applied during the flame penetration test. Being able to use a smaller yarn diameter while still being able to pass the flame penetration test contributes to an overall lower cost for the duct.

The embodiment showing the yarn positioned between wire segments of a duct section that has a spiral wound polymer core is shown in FIG. 16. This embodiment of the invention entails positioning the yarn so that it is disposed generally centrally between the wires that are part of the duct. This embodiment is illustrated in FIG. 16, wherein a duct section for testing is designated by reference numeral 130 and the frame holding the duct is schematically shown as 132. This duct section is taken from a duct, wherein the duct includes a spiral wound wire 131, and a spiral wound core 134 with an overlap seam 133 and overlap zone 135. The wire 131 is shown associated with the overlap zone 135. In the embodiments above, the yarn is shown crossing the overlap zone in some way. However, in this embodiment, the yarn, which is designated by reference numeral 137, is positioned on the duct outer surface such that it is generally centered between pairs of adjacent wires 131.

With the duct section disposed in the frame with the yarn containing surface facing downward, a weight 139 is positioned between the wires 131, the weight representing the weight used in the flame penetration test noted above. With the yarn positioned between the wires of the duct, when a duct section is taken from the duct, the yarn would be positioned beneath the weight during the flame penetration test. With the yarn between the wires and beneath the weight, the yarn would help support the weight and prevent the duct from failing at the overlap zone 135. In this embodiment, it is believed that even a cold glue could be used as the adhesive for the duct and still meet the Class 1 duct requirements. The other adhesives as the hot melt adhesive or the high temperature adhesive could also be used as one adhesive for the overlap zone of the duct.

FIG. 17 shows yet another embodiment, wherein the yarn is again beneath the weight to enhance passing of the flame penetration test. In this embodiment, the duct section is designated as 140, with the frame schematically shown as 142, the duct section made from a spiral wound core 144 whose spiral winding differs from that of FIG. 16. The helical wire is shown as 141. The core 144 includes a seam 143 and an overlap zone 145. The overlap zone 145 is generally centered between two segments of the wire 141. The yarn is wound on the core 144 such that is aligns with the overlap zone 145, one overlap zone bearing the weight 149. As with the embodiment of FIG. 16, the yarn is positioned on the duct so that when the duct section is used for a flame penetration test, the yarn is positioned between the wire segments 141 of the duct section 140, thus supporting the weight during the flame penetration test and assisting in maintaining the integrity of the duct overlap zone for flame penetration testing.

FIG. 18 shows yet another embodiment, wherein an S-TL duct is used with yarn to ensure passing the flame penetration test. This duct section is designated by reference numeral 160 and it has wire segments 161, overlap zone 163 and overlap seam 165. The yarn 167 could still be wound around the duct so that it is positioned between the wire segments 161 to help support the weight 169. In this embodiment, since the overlap zone is not parallel to the wire of the duct, the yarn would also cross over the overlap zones, further holding the duct section together against the weight and facilitating passing of the flame penetration test as a result of this crossing of the overlap zone with the yarn.

In the embodiments of FIGS. 16 and 17, the flame resistant barrier material could be positioned on the inside of the spiral wound core. In these embodiments, the spiral wound PET core would face the flame of the flame penetration test and fire resistant barrier material would receive the weight used in the flame penetration test. With the yarn beneath the weight, the integrity of the duct is improved to avoid duct failure during the flame penetration test.

Besides providing an improved uninsulated flexible duct that provides better assurance that the duct can pass the tests necessary to meet the UL 181 Class 1 duct requirements, the invention also includes a method of using the duct to move unconditioned or conditioned air to a desired space in a desired structure. The uninsulated flexible duct with its flame resistant yarn positioned on an outer side of it can be used where any known uninsulated flexible ducts are used to move unconditioned or conditioned air.

While a yarn is exemplified as the kind of material that would surround the outside of the uninsulated flexible duct, any material that is in the shape of a yarn, cord, filament, or the like that would have the properties described above can be used as the medium to surround the duct and provide support for the overlap zones during UL 181 testing. Thus, yarn is used to represent the kind of elongated and strand like materials for purposes of describing the invention.

The invention also includes a method of obtaining a section of the inventive uninsulated flexible duct and placing it in a frame that is used as part of a test rig for flame penetration testing under the Class 1 UL 181 standard. The frame rests over a furnace with an open flame, with the flame resistant yarn-containing surface of the duct section, which is the outer surface of the duct itself, facing the open flame. The flame resistant yarn positioned on the outer surface of the duct provides support for any bonded overlap zones of the fire resistant barrier material making up the duct wall during the flame penetration test. With the flame resistant yarn in place, the integrity of the duct section is maintained even if the bond in one or more overlap zones of the duct that are part of the duct section to be tested should weaken or fail.

The various embodiments described above are provided by way of illustration only and should not be construed to limit the claims attached hereto.

Those skilled in the art will readily recognize various modifications and changes that may be made without following the example embodiments and applications illustrated and described herein, and without departing from the true spirit and scope of the following claims.

I claim:

1. An uninsulated flexible duct comprising:
a duct wall, the duct wall having an outer surface and an inner surface, the duct wall forming a channel for fluid flow therethrough, the duct wall including a helical wire;
a fire resistant barrier material forming a part of the duct wall, the fire resistant barrier material including an overlap zone, wherein a first surface of the fire resistant barrier material faces a second surface of the fire resistant barrier material, the first and second surface of the overlap zone bonded together, the overlap zone running along a length of the uninsulated flexible duct; and
a flame resistant yarn adhered to an outer surface of the duct in a path that crosses or at least partially covers the overlap zone or in a path wherein the yarn is centrally positioned between adjacent helical wires so that the yarn would be generally aligned with a weight placed between helical wires in a flame penetration test.

2. The duct of claim 1, wherein the fire resistant barrier layer forms the outer surface of the duct.

3. The duct of claim 1, wherein the overlap zone runs generally longitudinally along a length of the duct and the path of the flame resistant yarn crosses the overlap zone a plurality of times along a length of the duct.

4. The duct of claim 2, wherein the overlap zone runs generally longitudinally along a length of the duct and the path of the flame resistant yarn crosses the overlap zone a plurality of times along a length of the duct.

5. The duct of claim 1, wherein the overlap zone runs in a spiral path along the length of the duct.

6. The duct of claim 5, wherein the path of the flame resistant yarn is one of:
a) a spiral path having a helix angle that is different than a helix angle of the spiral path of the overlap zone so that the flame resistant yarn crosses over or intersects the overlap zone; and
b) a spiral path having a helix angle the same as the spiral path of the overlap zone and wherein the spiral path of the flame resistant yarn is parallel to the spiral path of the overlap zone so that the flame resistant yarn runs along the overlap zone.

7. The duct of claim 1, wherein the overlap zone is bonded by chemical welding.

8. The duct of claim 2, wherein the overlap zone is bonded by chemical welding.

9. The duct of claim 1, wherein the overlap zone is bonded with one adhesive, or a combination of adhesives, the combination comprising either:
(i) a combination of at least first and second adhesives between in the overlap zone, the first adhesive as a hot melt adhesive in an effective amount to immediately bond the overlapping portions together, the second adhesive as a high temperature adhesive in an effective amount to maintain the bond between the overlapping portions when the longitudinal seam or spirally wound seam is subjected to a flame penetration test according to the UL 181 Class 1 duct standard; or
(ii) a combination of at least first and second adhesives in the overlap zone, the first adhesive as a hot melt adhesive in an effective amount to immediately bond the overlapping portions together, the second adhesive as a cold glue in an effective amount to maintain the bond between the overlapping portions when the longitudinal seam or spirally wound seam is subjected to a high temperature test according to the UL 181 Class 1 duct standard.

10. The duct of claim 1, wherein the fire resistant barrier material includes a coating thereon.

11. The duct of claim 1, wherein the duct wall includes at least one polymer layer as a part thereof, the at least one polymer layer and the fire resistant barrier material forming a laminate construction for the duct wall.

12. The duct of claim 11, wherein the fire resistant barrier material forms an outer surface of the uninsulated flexible duct.

13. The duct of claim 11, wherein the fire resistant barrier material forms an inner surface of the uninsulated flexible duct.

14. The duct of claim 1, wherein the flame resistant yarn is adhered to an outer surface of the fire resistant barrier material by one of:
a) a high temperature adhesive;
b) a polyvinylchloride coating on the yarn and tetrahydrofuran applied to the coated yarn to chemically weld it to the outer surface of the duct;
c) a coating applied to the yarn and fire resistant barrier material, and
d) a stitching of the flame resistant yarn to the outer surface of the duct.

15. The duct of claim 1, wherein the fire resistant barrier material is coated and forms both an inner and outer surface of the duct, the overlap zone runs generally longitudinally along a length of the duct, and the path of the flame resistant yarn is a spiral path that crosses over or intersects the overlap zone.

16. In a method of flame penetration testing of a duct, wherein an outer surface of a section of uninsulated flexible duct is configured to face a furnace with an open flame, the improvement comprising providing the section of duct from the duct of claim 1.

17. In a method of moving conditioned or unconditioned fluid, preferably air, using an uninsulated flexible duct, the improvement comprising providing the duct of claim 1 as the uninsulated flexible duct to move the conditioned or unconditioned fluid.

18. The duct of claim 9, wherein the one adhesive is one of the hot melt adhesive, the cold glue, or the high temperature adhesive.
